(19) United States
(12) Patent Application Publication
(10) Pub. No.: US 2016/0171614 A1
(43) Pub. Date: Jun. 16, 2016

(54) SYSTEM AND METHOD FOR AN INTERACTIVE CROWDFUNDING PLATFORM

(71) Applicant: Don M. BUCKNER, Okahumpka, FL (US)

(72) Inventor: Don M. BUCKNER, Okahumpka, FL (US)

(21) Appl. No.: 15/053,049

(22) Filed: Feb. 25, 2016

Related U.S. Application Data
(63) Continuation-in-part of application No. 14/316,297, filed on Jun. 26, 2014.

(51) Int. Cl. G06Q 40/06; H04N 21/858; H04N 21/8545; H04N 21/81; G06Q 50/00; H04N 21/478; H04N 21/2668; H04N 21/61; G06Q 30/02; H04N 21/262; H04N 21/472

(52) U.S. Cl. CPC G06Q 40/06; H04N 21/26283; H04N 21/8586; H04N 21/8545; H04N 21/812; H04N 21/47214; H04N 21/47815; H04N 21/2668; H04N 21/47805; H04N 21/6125; H04N 21/6131; G06Q 30/0267; G06Q 50/01

(57) ABSTRACT

A method for an interactive crowdfunding platform includes receiving on at least one device a plurality of video crowdfunding offerings from a production server for products each associated with a respective data portal, where the video crowdfunding offerings are in a format viewable on at least one device of a viewer, and transmitting a response to the respective data portal to indicate to purchase a security for the product based on a respective video crowdfunding offering. A microprocessor of the production server is configured to transmit an alert to the at least one device of the viewer in response to at least one video crowdfunding offering matching stored preferences for the viewer. The alert includes at least one of an investment category, a price for the security, and a universal resource locator (URL) that specifies the location of the data portal to purchase the security.

### FIELD OF THE INVENTION

The present invention relates to the field of communications and, more particularly, to a system and method for an interactive crowdfunding platform.

### BACKGROUND OF THE INVENTION

Reality television provides an opportunity for contestants to perform on a national, and possibly an international, stage for the public. Often times the show rules allow the viewers watching the program to vote for a particular contestant, which permits that contestant to continue participating in the show. For example, viewers may use text messaging to interact by voting for a contestant during a designated time period after viewing the program. Subsequently during the next airing of an episode of the program, for example, the voting results are revealed to the contestants and the audience. A shortcoming of the existing reality television shows is that there is no instant and real time feedback provided by the viewers other than an anonymous vote. Another shortcoming is the allocation of prizes to the contestants. Typically, the production company awards money prizes to the “winning” contestants in accordance with the rules of the particular program such as who garners the most votes from the viewers. The viewers again have no opportunity to provide any more support (or money) to the particular contestant other than an anonymous vote that may cost a nominal amount charged by the production company if voting by text message, for example.

Online crowdfunding is often used for raising money needed for development of new products or ventures. Crowdfunding works by having a large number of people commit smaller amounts of money to help reach a set fundraising amount, and relies on using the social reach and larger network of connected individuals online.

A typical crowdfunding model includes using a website to advertise a number of products under development by different entrepreneurs. Upon selecting a product, the viewer will then be able to see more detailed information about the product before choosing to contribute or share with their social networks. If the viewer decides to contribute to the development of the product, the viewer is given a reward as an incentive and is based on the amount of the contribution. The reward may be, for example, a finished product once the product is fully developed and ready for market. The contributions are typically used to complete the development of the product and to promote the product once it is ready to be sold to the public.

Recently, equity crowdfunding has become an alternative to the typical crowdfunding model explained above. Equity crowdfunding allows viewers to receive equity in the company they are helping to fund. The viewers become actual investors in the business and thus, equity crowdfunding has created a new way for individuals to make early-stage investments in companies. An entrepreneur can now raise the necessary funds from a large number of viewers (i.e., investors), each supplying a small portion of the total, in exchange for equity in the business.

However, a shortcoming of crowdfunding is that the exposure of the product to potential viewers as investors is limited to the Internet, which consequently results in taking longer to reach the necessary funding and the possibility of competitors having their product to market first. Accordingly, there is a need for an interactive crowdfunding platform that increases the exposure of a product while also increasing the ability for viewers to timely invest in a product under development in order to reach the fund raising goal quickly.

### SUMMARY OF THE INVENTION

In view of the foregoing background, it is therefore an object of the present invention to provide an interactive crowdfunding platform that improves communications between entrepreneurs and investors.

This and other objects, features, and advantages in accordance with the present invention are provided by a method that includes broadcasting a video crowdfunding offering of a selected entrepreneur to persuade viewers to invest in a particular product or service.

In a particular embodiment, the method of an interactive crowdfunding platform includes storing a graphical user interface (GUI) on a device of a viewer, and receiving a video crowdfunding offering for a product at a production server sent from a data portal. The production server includes a microprocessor and a memory that stores preferences of the viewer for video format, destination address, specified investment value, investment category, and transmission schedule, for example. The microprocessor filters the received video crowdfunding offering by comparing content of the received video crowdfunding offerings to the stored preferences of the viewer to find a match, and generates an alert in response to a matched filtered video crowdfunding offering.

The alert may include at least one of the investment category, the investment value, and a universal resource locator (URL), which specifies the location of the data portal. The microprocessor is also configured to transmit the alert to the GUI of the viewer, where the alert activates the GUI to cause the alert to display on the device of the viewer and to enable connection via the URL to the data portal and to enable the viewer to invest in the product shown in the video crowdfunding offering.

The device of the viewer may a cellular device or a remote computer. The alert may be transmitted to the GUI over the Internet, or over a wireless communication channel to the device associated with the viewer based upon the destination address and the transmission schedule. The method may also include connecting the device to a computer of the viewer where the computer is connected to the Internet.

The specified investment value is a price advertised to the public for the securities being offered. The content of the video crowdfunding offering may include the target offering amount, the deadline to reach the target offering amount, and whether the company will accept investments in excess of the target offering amount.

In addition, the method may include receiving the video crowdfunding offering for the product at a television set of the viewer, displaying the video crowdfunding offering on the television set, and connecting via the URL to the data portal using the GUI to enable the viewer to invest in the product shown in the video crowdfunding offering displayed on the television set.

In another particular embodiment, a method for an interactive crowdfunding platform includes transmitting a plurality of video crowdfunding offerings from a production server to a plurality of viewers for products each associated with a respective data portal, where the video crowdfunding offerings in a format viewable on a respective device of the viewers. The method also includes receiving a response at the respective data portal from at least one viewer in response to the viewer indicating to purchase a security for the product based on a respective video crowdfunding offering.

In another aspect of the present invention, a method for an interactive crowdfunding platform includes receiving on at least one device a plurality of video crowdfunding offerings from a production server for products each associated with a respective data portal, where the video crowdfunding offerings are in a format viewable on at least one device of a viewer. The method also includes transmitting a response to the respective data portal to indicate to purchase a security for the product based on a respective video crowdfunding offering.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a particular illustrative embodiment of a system for an interactive crowdfunding platform, where a producer selects a pool of participants at a remote location;

FIG. 2 is a particular illustrative embodiment of the system for the interactive crowdfunding platform, where a mobile television studio is used to transmit the performance to the production server;

FIG. 3 is a schematic of a particular illustrative embodiment of the video crowdfunding offering and results viewed on a television (or mobile device) by the public;

FIG. 4 is a flow diagram of a particular illustrative embodiment of a method for an interactive television show;

FIG. 5 is a flow diagram of a particular illustrative embodiment of a method for an interactive crowdfunding platform; and

FIG. 6 is a block diagram of a particular illustrative embodiment of the system for the interactive crowdfunding platform.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The system and method for an interactive crowdfunding platform is intended to be the most real of all reality shows. The program may be even shot remotely outdoors and a mobile television studio may be used to travel to seek out participants who have a product to sell, for example. The participants may explain their product and tell their personal story, which may encourage the public to invest in their product. For example, the presentation may be a pitch to persuade viewers to invest in a particular product or service using an equity crowdfunding model. Accordingly, the viewers may purchase securities and obtain equity in the product or services. Thus, the viewers may eventually receive a percentage of any profits that may be generated in the future. The viewers may purchase securities using the Internet, social media, mobile devices, or any combination thereof, through the interactive crowdfunding platform described below.

In operation, the method may include receiving a video crowdfunding offering for a product at a production server sent from a mobile television studio or data portal (e.g., Universal Resource Locator “URL”). The production server includes a microprocessor and a memory that stores preferences of the viewer for video format, destination address, specified investment value, investment category, and transmission schedule. The microprocessor filters the received video crowdfunding offering by comparing content of the received video crowdfunding offerings to the stored preferences of the viewer to find a match, and generates an alert in response to a matched filtered video crowdfunding offering.

The alert may include an investment category such as medical, software, hardware, technical, retail, consumer, green technology, construction, transportation, websites, child related, senior related, student related, travel, entertainment, music, movies, agriculture, food processing, pets, defense, quality of life, and online retail, for example. The alert may also include the investment value or price for the security, and a universal resource locator (URL), which specifies the location of the data portal and other information used to communicate with the participant. The microprocessor is also configured to transmit the alert to the GUI of the viewer, where the alert may automatically activate the GUI to cause the alert to display on the device of the viewer and to enable connection via the URL to the data portal and to enable the viewer to invest in the product shown in the video crowdfunding offering.

The device of the viewer may be a cellular device or a remote computer. The alert may be transmitted to the GUI over the Internet, or over a wireless communication channel to the device associated with the viewer based upon the destination address and the transmission schedule. The method may also include connecting the device to a computer of the viewer where the computer is connected to the Internet.

The specified investment value is a price advertised to the public for the securities being offered. The content of the video crowdfunding offering may include the target offering amount, the deadline to reach the target offering amount, and whether the company will accept investments in excess of the target offering amount.

In addition, the method may include receiving the video crowdfunding offering for the product at a television set of the viewer, displaying the video crowdfunding offering on the television set, and connecting via the URL to the data portal using the GUI to enable the viewer to invest in the product shown in the video crowdfunding offering displayed on the television set.

The device of the viewer may a cellular device or a remote computer. The alert may be transmitted to the GUI over the Internet, or over a wireless communication channel to the device associated with the viewer based upon the destination address and the transmission schedule. The method may also include connecting the device to a computer of the viewer where the computer is connected to the Internet.

The specified investment value is a price advertised to the public for securities being offered. The content of the video crowdfunding offering may include the target offering amount, the deadline to reach the target offering amount, and whether the company will accept investments in excess of the target offering amount.

In another particular embodiment, a method for an interactive crowdfunding platform includes transmitting a plurality of video crowdfunding offerings from a production server to a plurality of viewers for products each associated with a respective data portal, where the video crowdfunding offerings are in a format viewable on a respective device of the viewers. The method also includes receiving a response at the respective data portal from at least one viewer in response to the viewer indicating to purchase a security for the product based on a respective video crowdfunding offering.

The production server includes a microprocessor and a memory that stores preferences of the viewer. The microprocessor may be configured to transmit an alert to the respective device of the viewer in response to at least one video crowdfunding offering matching the stored preferences for the respective viewer. The alert may include at least one of an investment category, a price for the security, and a universal resource locator (URL) that specifies the location of the data portal to purchase the security.

The alert may be transmitted to the respective device over the Internet, or over a wireless communication channel to the respective device.

In another aspect of the present invention, a method for an interactive crowdfunding platform includes receiving on at least one device a plurality of video crowdfunding offerings from a production server for products each associated with a respective data portal, where the video crowdfunding offerings are in a format viewable on at least one device of a viewer. The method also includes transmitting a response to the respective data portal to indicate to purchase a security for the product based on a respective video crowdfunding offering.

The at least one device may include a microprocessor and a memory that stores preferences of the viewer, where the microprocessor is configured to transmit an alert to the at least one device of the viewer in response to at least one video crowdfunding offering matching the stored preferences for the viewer. The alert may include at least one of an investment category, a price for the security, and a universal resource locator (URL) that specifies the location of the data portal to purchase the security. The alert may be transmitted to the respective device over the Internet, wireless communication channel, or any combination thereof.

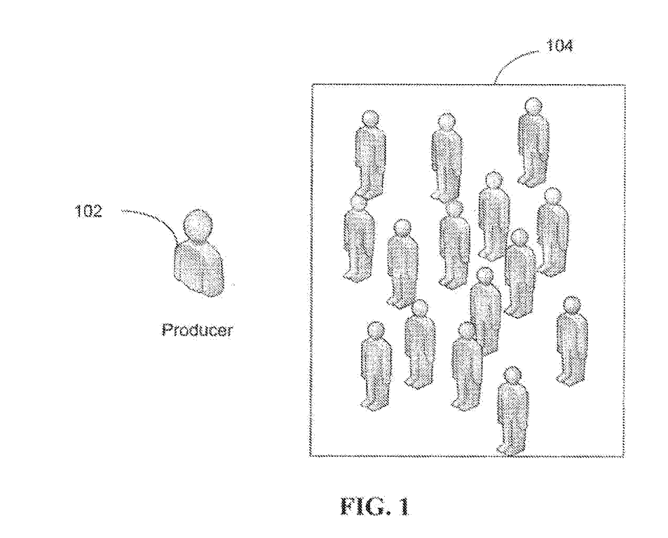

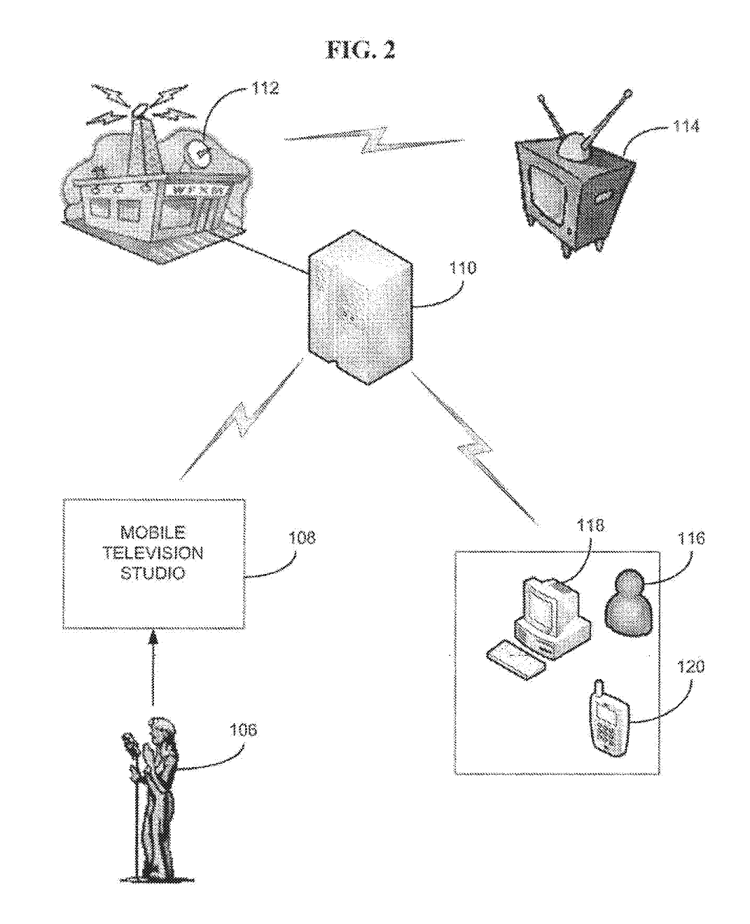

Referring now to FIGS. 1 and 2, a producer 102 may identify a pool of participants 104 such as entrepreneurs, for example. The producer 102 may travel to a remote location to the participants 104. Once the participants are selected, each selected participant 106 is provided an opportunity to discuss their personal background before beginning their video crowdfunding offerings.

In one particular illustrative embodiment, a mobile television studio 108 transmits the video crowdfunding offering in real-time back to a production server 110 that is in communication with the broadcast station 112. The broadcast station 112 then broadcasts the video crowdfunding offering to the public, where it may be viewed on a television 114 or graphical user interface (GUI) of a mobile device, for example. While the video crowdfunding offering is being broadcast, a viewer 116 may purchase a security being offered by the participant 106 using a computer 118 in communication with the Internet or a mobile device 120 to transmit to the production server 110 or other suitable platform as will be appreciated by those of ordinary skill in the art. Alternatively, the video crowdfunding offering may be transmitted over the Internet to the production server from a data portal (URL) of the participant 106.

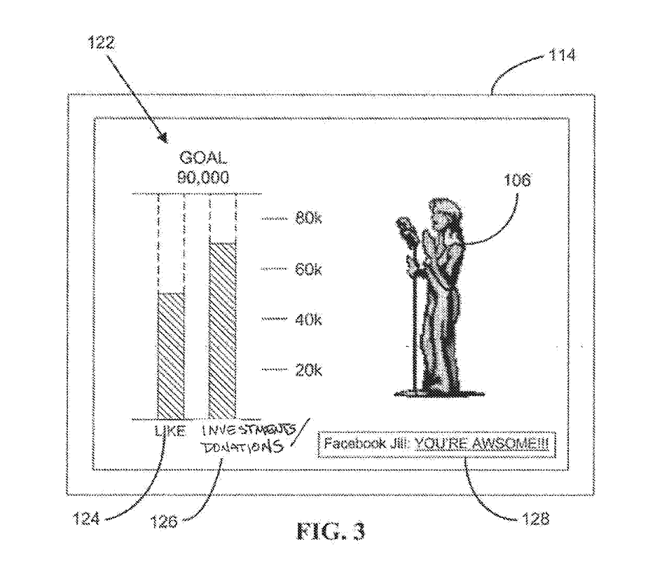

An example of the broadcast of the video crowdfunding offering displayed on a television 114 is shown in FIG. 3. The participant 106 is shown presenting her product with results 124 and investments 126 also displayed. In this particular embodiment, the real-time results 122 of the voting 124 and investments 126 are illustrated as a bar chart, where the height of the bar reflects the respective totals. In addition, messages 128 from the public may also be displayed as part of the broadcast.

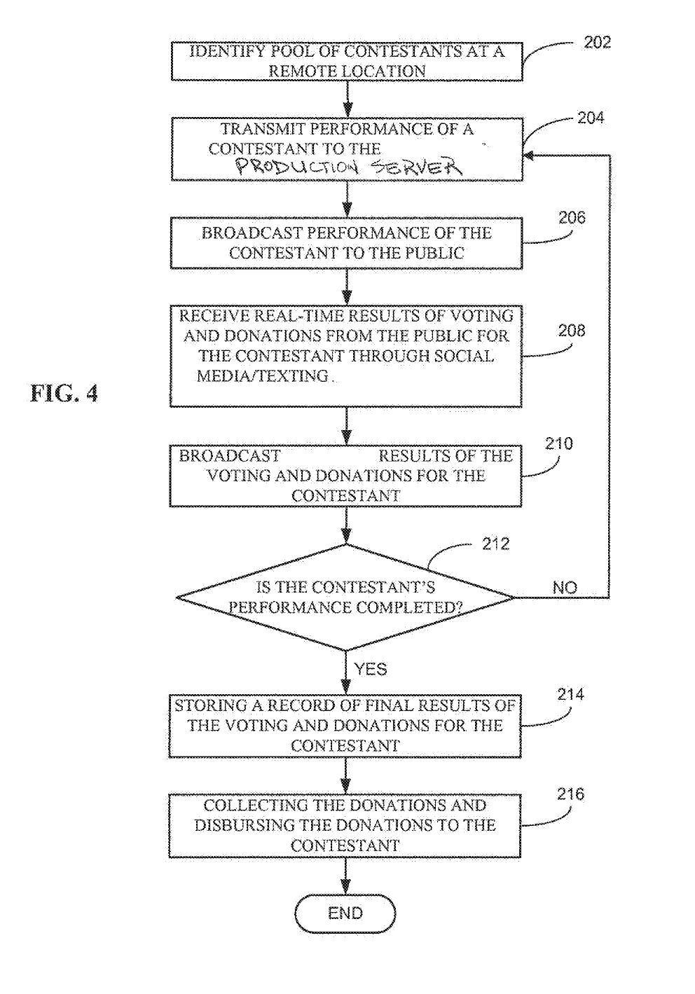

A flow diagram of a particular alternative embodiment of a method of an interactive program is described in FIG. 4 for a participant attempting to raise donations, rather than investments. At 202, a pool of contestants at a remote location are identified. Moving to 204, a performance of the contestant, such as singing or dancing, is broadcast from the mobile television studio to the production server. The performance of the contestant is broadcast to the public from the broadcast station, at 206. The results of voting and donations from the public for the contestant are received, at 208, through social media, mobile devices, the Internet, or any combination thereof. The results of the voting and donations for the contestant are broadcast, at 210. At 212, the performance and results continue to be broadcast until the performance is completed. A record of the final results of the voting and donations for the contestant is stored, at 214. The donations are collected, at 216, and disbursed to the contestant.

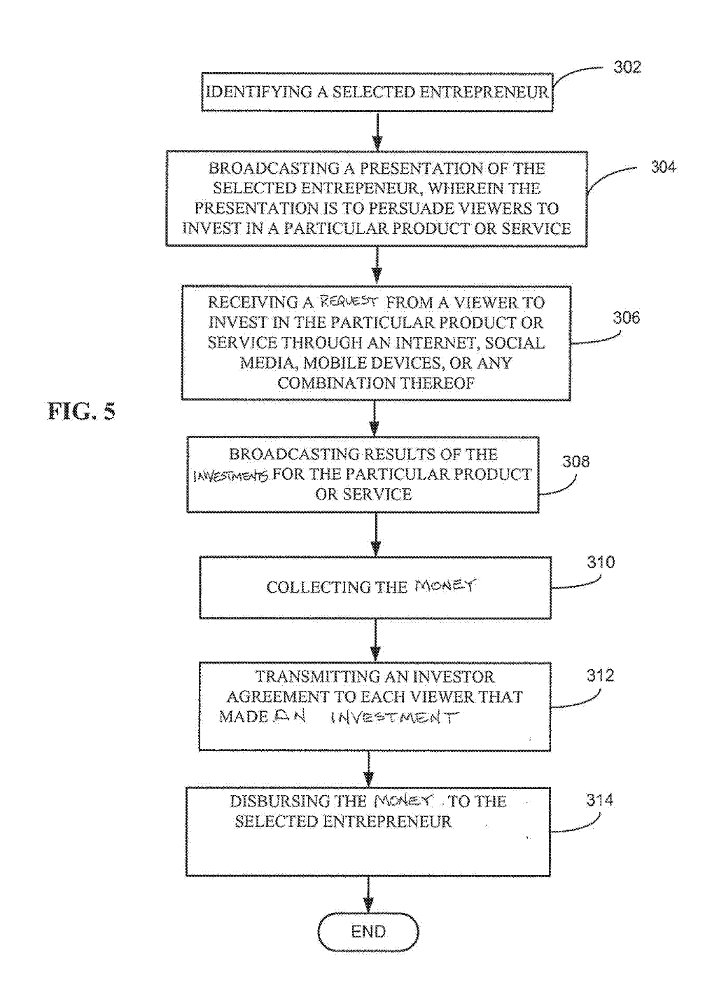

Referring now to FIG. 5, a flow diagram of a particular embodiment of a method of an interactive crowdfunding platform is described. Similar to that described above, a participant is selected, at 302, from a pool of contestants. Moving to 304, the video crowdfunding offering of the participant is broadcast from the mobile television studio to the production server, where the video crowdfunding offering is to persuade viewers to invest in a particular product or service. Requests are received, at 306, from viewers to purchase securities in order to invest in the particular product or service through the Internet, social media, mobile devices, or any combination thereof. The results of the investments from the viewers is broadcast, at 308, and, at 310, the money is collected from those that indicated they wanted to invest. An investor agreement is transmitted, at 312, to each viewer that invested and the money is disbursed to the entrepreneur, at 314.

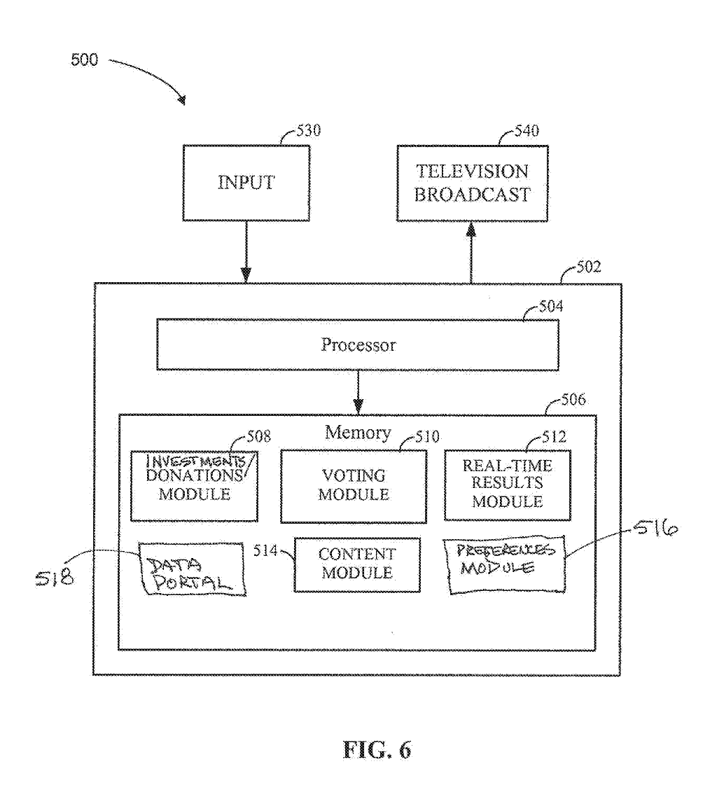

Referring to FIG. 6, a particular illustrative embodiment of a system for broadcasting the interactive program is depicted and generally designated 500. The system 500 includes a processor 504 that is in communication with an input device 530, where a memory 506 of a production server 502 may be configured to store the results received for a particular participant. An investments module 508 may be used to record and store the responses and information received for a particular contestant through social media, mobile, devices, or the Internet, for example, and to provide the investment information to the television broadcast in real-time. A voting module 510 may be used to receive and record voting results for a particular contestant and to provide the voting results to the television broadcast. A results module 512 may be used to analyze the investments and voting information and format the information appropriately for display on a television or GUI of a mobile device. This may include bar charts of the voting and investment results, indicate goals, or a simple number tally, for example. A content module 514 may be used to embed the real-time results into the performance of the participant being currently broadcast. A preferences module 516 may be used to store preferences for the video format, destination address, specified investment value, investment category, and transmission schedule, for the respective viewers. The memory 506 may also store the URL for a data portal 518, where the URL for the data portal may be assigned to a particular participant or platform to transmit the video crowdfunding offering and to receive investments and interact with the viewers related to the crowdfunding offering. In addition, a transmitter or other output device 540 may be in direct communication with the production server 502, where the output device 540 transmits the video crowdfunding offering and results to the public for viewing on a television or mobile device, for example.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method for an interactive crowdfunding platform, the method comprising:
storing a graphical user interface (GUI) on a device of a viewer; and
receiving a video crowdfunding offering for a product at a production server sent from a data portal, the production server comprising a microprocessor and a memory that stores preferences of the viewer for video format, destination address, specified investment value, investment category, and transmission schedule, wherein the microprocessor
filters the received video crowdfunding offering by comparing content of the received video crowdfunding offerings to the stored preferences of the viewer to find a match,
generates an alert in response to a matched filtered video crowdfunding offering, the alert includes at least one of the investment category, the investment value, and a universal resource locator (URL), which specifies the location of the data portal, and
transmits the alert to the GUI of the viewer,
wherein the alert activates the GUI to cause the alert to display on the device of the viewer and to enable connection via the URL to the data portal and to enable the viewer to invest in the product shown in the video crowdfunding offering.

2. The method of claim 1, wherein the device of the viewer is a cellular device.

3. The method of claim 1, wherein the device is a remote computer.

4. The method of claim 1, wherein the alert is transmitted to the GUI over the Internet.

5. The method of claim 1, wherein the alert is transmitted over a wireless communication channel to the device associated with the viewer based upon the destination address and the transmission schedule.

6. The method of claim 1, the method further comprising connecting the device to a computer of the viewer and the computer is connected to the Internet.

7. The method of claim 1, wherein the specified investment value is a price advertised to the public for securities being offered.

8. The method of claim 1, wherein the content of the video crowdfunding offering comprises the target offering amount, the deadline to reach the target offering amount, and whether the company will accept investments in excess of the target offering amount.

9. The method of claim 1, further comprising:
receiving the video crowdfunding offering for the product at a television set of the viewer;
displaying the video crowdfunding offering on the television set; and
connecting via the URL to the data portal using the GUI to enable the viewer to invest in the product shown in the video crowdfunding offering displayed on the television set.

10. A method for an interactive crowdfunding platform, the method comprising:
transmitting a plurality of video crowdfunding offerings from a production server to a plurality of viewers for products each associated with a respective data portal, the video crowdfunding offerings in a format viewable on a respective device of the viewers; and
receiving a response at the respective data portal from at least one viewer in response to the viewer indicating to purchase a security for the product based on a respective video crowdfunding offering.

11. The method of claim 10, wherein the production server comprises a microprocessor and a memory that stores preferences of the viewer.

12. The method of claim 11, wherein the microprocessor is configured to transmit an alert to the respective device of the viewer in response to at least one video crowdfunding offering matching the stored preferences for the respective viewer.

13. The method of claim 12, wherein the alert includes at least one of investment category, a price for the security, and a universal resource locator (URL) that specifies the location of the data portal to purchase the security.

14. The method of claim 12, wherein the alert is transmitted to the respective device over the Internet.

15. The method of claim 12, wherein the alert is transmitted over a wireless communication channel to the respective device.

16. A method for an interactive crowdfunding platform, the method comprising:
receiving on at least one device a plurality of video crowdfunding offerings from a production server for products each associated with a respective data portal, the video crowdfunding offerings in a format viewable on at least one device of a viewer; and
transmitting a response to the respective data portal to indicate to purchase a security for the product based on a respective video crowdfunding offering.

17. The method of claim 16, wherein the at least one device comprises a microprocessor and a memory that stores preferences of the viewer.

18. The method of claim 17, wherein the microprocessor is configured to transmit an alert to the at least one device of the viewer in response to at least one video crowdfunding offering matching the stored preferences for the viewer.

19. The method of claim 18, wherein the alert includes at least one of an investment category, a price for the security, and a universal resource locator (URL) that specifies the location of the data portal to purchase the security.

20. The method of claim 12, wherein the alert is transmitted to the respective device over the Internet, wireless communication channel, or any combination thereof.
